(19) United States
(12) Patent Application Publication
(10) Pub. No.: US 2026/0292286 A1
(43) Pub. Date: Sep. 24, 2026

(54) MEDIA CONTENT GENERATION METHOD, APPARATUS, DEVICE, MEDIUM, AND PRODUCT

(71) Applicant: Bytedance Technology Ltd., Grand Cayman (KY)

(72) Inventors: Jiaxin MA, Beijing (CN); Yijie XIE, Los Angeles, CA (US)

(21) Appl. No.: 19/539,992

(22) Filed: Feb. 13, 2026

(30) Foreign Application Priority Data
Mar. 24, 2025 (CN) 202510354746.0

(51) Int. Cl. H04N 21/2665; H04N 21/81

(52) U.S. Cl. CPC H04N 21/2665; H04N 21/812

(57) ABSTRACT

Embodiments of the present disclosure provide a media content generation method and apparatus, a device, a medium, and a product. The method includes: displaying, in response to a first trigger operation for generating media content, at least two pieces of preview media content on a shooting page according to preset page layout information, wherein content corresponding to the at least two pieces of preview media content is the same; replacing, in response to detecting that an event of acquiring the media content is satisfied, the preview media content with acquired first media content; and determining, for the at least two pieces of first media content displayed, second media content in a first style type from the first media content, and displaying the second media content, wherein content of the at least two pieces of first media content is the same and style types of the second media content are different.

### CROSS-REFERENCE TO RELATED APPLICATIONS

The present disclosure claims the priority from the CN patent application No. 202510354746.0 entitled “Media content generation method, apparatus, device, medium, and product” filed with the China National Intellectual Property Administration (CNIPA) on Mar. 24, 2025, the contents of which are hereby incorporated by reference in their entirety.

### FIELD

Embodiments of the present disclosure relate to the field of computer processing technologies and, in particular, to a media content generation method and apparatus, a device, a medium, and a product.

### BACKGROUND

Currently, images may be stylized based on a style model integrated in an application software, and corresponding style images may be displayed.

### SUMMARY

The present disclosure provides a media content generation method and apparatus, a device, a medium, and a product.

According to a first aspect, an embodiment of the present disclosure provides a media content generation method. The method includes:

displaying, in response to a first trigger operation for generating media content, at least two pieces of preview media content on a shooting page according to preset page layout information, wherein content corresponding to the at least two pieces of preview media content is the same;

replacing, in response to detecting that an event of acquiring the media content is satisfied, the preview media content with acquired first media content; and

determining, for the at least two pieces of first media content displayed, second media content in a first style type from the first media content, and displaying the second media content on the shooting page,

where content of the at least two pieces of first media content is the same, style types of the second media content corresponding to the at least two pieces of first media content are different, and type information of the style types is related to the preset page layout information.

According to a second aspect, an embodiment of the present disclosure further provides a media content generation apparatus. The apparatus includes:

a preview media content display module configured to display, in response to a first trigger operation for generating media content, at least two pieces of preview media content on a shooting page according to preset page layout information, wherein content corresponding to the at least two pieces of preview media content is the same;

a first media content display module configured to replace, in response to detecting that an event of acquiring the media content is satisfied, the preview media content with acquired first media content; and

a second media content display module configured to determine, for the at least two pieces of first media content displayed, second media content in a first style type from the first media content, and display the second media content on the shooting page,

where content of the at least two pieces of first media content is the same, style types of the second media content corresponding to the at least two pieces of first media content are different, and type information of the style types is related to the preset page layout information.

According to a third aspect, an embodiment of the present disclosure further provides an electronic device. The electronic device includes:

one or more processors; and

a storage apparatus configured to store one or more programs,

where the one or more programs, when executed by the one or more processors, cause the one or more processors to implement the media content generation method according to any one of the embodiments of the present disclosure.

According to a fourth aspect, an embodiment of the present disclosure further provides a storage medium including computer-executable instructions. The computer-executable instructions, when executed by a computer processor, are used for performing the media content generation method according to any one of the embodiments of the present disclosure.

According to a fifth aspect, an embodiment of the present disclosure further provides a computer program product, including a computer program. The computer program, when executed by a processor, implements the media content generation method according to any one of the embodiments of the present disclosure.

### BRIEF DESCRIPTION OF THE DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a media content generation method according to an embodiment of the present disclosure;

FIG. 2 is a schematic diagram of adjusting a display form of preview media content according to preset page layout information according to an embodiment of the present disclosure;

FIG. 3 is a schematic interface diagram of acquiring first media content according to an embodiment of the present disclosure;

FIG. 4 is a schematic flowchart of a media content generation method according to an embodiment of the present disclosure;

FIG. 5 is a schematic diagram of displaying a layout configuration page according to an embodiment of the present disclosure;

FIG. 6 is a schematic diagram of a trajectory drawing interface according to an embodiment of the present disclosure;

FIG. 7 is a schematic diagram of a style type configuration interface according to an embodiment of the present disclosure;

FIG. 8 is a schematic flowchart of a media content generation method according to an embodiment of the present disclosure;

FIG. 9 is an interface diagram of switching from displaying preview media content to displaying first media content according to an embodiment of the present disclosure;

FIG. 10 is an interface diagram of displaying second media content according to an embodiment of the present disclosure;

FIG. 11 is a schematic flowchart of a media content generation method according to an embodiment of the present disclosure;

FIG. 12 is a schematic diagram of comparison between second media content corresponding to a case where first media content is not focused and second media content corresponding to a case where the first media content is focused according to an embodiment of the present disclosure;

FIG. 13 is a schematic flowchart of a media content generation method according to an embodiment of the present disclosure;

FIG. 14 is a schematic interface diagram of transitioning from first media content to displaying second media content according to an embodiment of the present disclosure;

FIG. 15 is a schematic diagram of a structure of a media content generation apparatus according to an embodiment of the present disclosure; and

FIG. 16 is a schematic diagram of a structure of an electronic device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders and/or in parallel. In addition, the method implementations may include additional steps and/or omit performing illustrated steps. The scope of the present disclosure is not limited in this respect.

The term "include/comprise" and the variations thereof used herein are open-ended inclusions, that is, "include/comprise but not limited to". The term "based on" means "at least partially based on". The term "one embodiment" means "at least one embodiment". The term "another embodiment" means "at least one another embodiment". The term "some embodiments" means "at least some embodiments". Related definitions of other terms are given in the following description.

It should be noted that concepts such as "first" and "second" in the present disclosure are only used for distinguishing between different apparatuses, modules, or units and are not used for limiting the sequence of functions performed by these apparatuses, modules, or units or interdependence therebetween.

It should be noted that modifications of "one" and "a plurality of" mentioned in the present disclosure are illustrative rather than restrictive. Those skilled in the art should understand that unless otherwise explicitly specified in the context, they should be understood as "one or more".

The names of messages or information exchanged between a plurality of apparatuses in the implementations of the present disclosure are only for illustrative purposes and are not intended to limit the scope of these messages or information.

It may be understood that before the technical solutions disclosed in the embodiments of the present disclosure are used, the user should be informed of the type, the range of use, the use scenarios, etc., of personal information involved in the present disclosure in an appropriate manner and the authorization of the user should be obtained in accordance with related laws and regulations.

For example, in response to receiving an active request from a user, prompt information is sent to the user to clearly inform the user that the requested operation will require access to and use of personal information of the user. In this manner, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to receiving the active request from the user, the prompt information may be sent to the user in the form of, for example, a pop-up window, and the prompt information may be presented in text in the pop-up window. In addition, the pop-up window may also include a selection control for the user to choose whether to "agree" or "disagree" to provide the personal information to the electronic device.

It may be understood that the preceding process of notifying and acquiring user authorization is only illustrative and does not limit the implementations of the present disclosure. Other manners that satisfy related laws and regulations may also be applied to the implementations of the present disclosure.

It may be understood that data involved in the technical solution (including but not limited to the data itself, acquisition or use of the data) shall comply with requirements of corresponding laws, regulations, and related provisions.

Currently, images may be stylized based on a style model integrated in an application software, and corresponding style images may be displayed.

In the prior art, when style images are generated based on the above manner, there is a problem that the picture content is monotonous, resulting in a poor picture display effect.

The present disclosure provides a media content generation method and apparatus, a device, a medium, and a product. Media content in a plurality of style types may be displayed on a same display page, thereby achieving an effect of enriching picture content and satisfying personalized requirements of users.

According to the technical solution provided in this embodiment of the present disclosure, in response to the first trigger operation for generating the media content, the preview media content may be displayed on the shooting page according to the preset page layout information. Because the preset page layout information includes a plurality of layout areas, the preview media content may be displayed in each of the plurality of layout areas. At this time, the displayed preview media content is the same. Further, when it is detected that the event of acquiring the media content is satisfied, the preview media content displayed in the layout area may be replaced with the first media content, that is, the first media content is displayed. In addition, when it is detected that a condition of displaying the second media content is satisfied, the first media content may be stylized according to the style type corresponding to each layout area in the preset page layout information, to obtain the second media content corresponding to each layout area and display the second media content. In this manner, at least two pieces of media content in style types may be displayed on the same page, thereby improving the richness of the picture content.

Before the technical solution provided in this embodiment of the present disclosure is described, an application scenario may be exemplarily described.

The technical solution provided in this embodiment of the present disclosure may be applied to any scenario in which media content may be generated. Optionally, the solution provided in this embodiment of the present disclosure may be integrated, as a functional module, into any existing application software that has image and video shooting functions. In actual application, if it is detected that the functional module in the application is triggered, the final second media content may be generated based on the solution provided in this embodiment of the present disclosure. Certainly, the solution provided in this embodiment of the present disclosure may alternatively be displayed, as an effect prop, in the application software with the shooting function. The effect prop may be displayed in the form of an icon in the application, and the icon may be a thumbnail set for the effect prop in advance, wherein the thumbnail corresponds to a display effect of the effect prop. When a trigger operation on the icon is detected, an effect resource corresponding to the icon is retrieved to generate the second media content based on the effect resource.

It should be noted that an apparatus for performing the media content generation method provided in this embodiment of the present disclosure may be integrated into the application software that supports an image processing function, and the software may be installed in an electronic device. Optionally, the electronic device may be a mobile terminal, a PC, or the like. The application software may be a type of software that processes images/videos, and the specific application software is not described herein again as long as image/video processing may be implemented. Alternatively, a specially developed application may be used for generating the media content, or the apparatus may be integrated into a corresponding page, and the user may generate the corresponding media content through the page integrated in the PC.

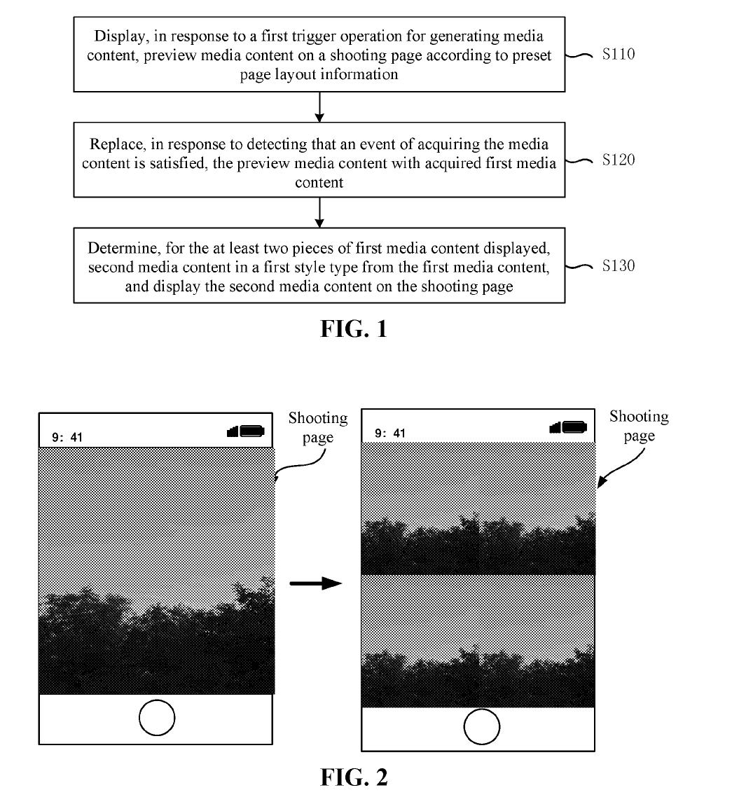

FIG. 1 is a schematic flowchart of a media content generation method according to an embodiment of the present disclosure. The embodiment of the present disclosure is applicable to any application software with a shooting function to generate a scenario in which media content in a plurality of style types may be displayed on a same page. The method may be performed by a media content generation apparatus. The apparatus may be implemented in the form of software and/or hardware, and optionally, the apparatus may be implemented by an electronic device, for example, a mobile terminal, a PC, or a server.

As shown in FIG. 1, the method in this embodiment may specifically include the following steps.

S110: Display, in response to a first trigger operation for generating media content, preview media content on a shooting page according to preset page layout information.

It should be noted that when it is detected that a function control integrated in an application and corresponding to the embodiment of the present disclosure is triggered or that an effect prop in the application is triggered, it indicates that the first trigger operation is triggered. Based on this, it may be learned that the first trigger operation is generated based on a trigger operation on a physical control displayed on a display interface.

Certainly, in actual application, the first trigger operation may alternatively be determined based on a trigger operation on a non-physical control. Optionally, when a display duration of the effect prop reaches a preset duration threshold on the shooting interface, it is determined that the first trigger operation is triggered.

After the first trigger operation for generating the media content is detected, a shooting function of a terminal device may be enabled to acquire media content within a field of view based on a shooting apparatus corresponding to the shooting function, and the media content may be used as the preview media content. In other words, after the shooting apparatus is enabled, the shooting apparatus may continuously acquire the media content, and the media content displayed on the shooting page is the preview media content.

It should be noted that the preview media content may be a video stream acquired by the shooting apparatus, and the video stream includes a plurality of video frames, wherein each video frame corresponds to an image and/or an audio and video frame acquired by the shooting apparatus.

Correspondingly, the shooting page may be understood as a page that displays the preview media content after the shooting apparatus is invoked. Generally, the shooting page is related to a display screen of the terminal device to which the shooting apparatus belongs. Optionally, the shooting page corresponds to the entire display screen.

In addition, in order to clearly understand the initial form corresponding to the triggered functional module or the triggered effect prop, the preset page layout information corresponding to the functional module or the effect prop may be acquired.

In this embodiment, the preset page layout information may be used for determining information such as the number of layout areas into which the shooting page may be divided and the size of each layout area. In other words, the preset page layout information is mainly used for representing the display area and the area size, on the shooting page, of the preview media content, the acquired first media content, and the processed second media content.

The preset page layout information includes area information of the layout area, and the area information may correspond to the shape and the area of the layout area. The shape of the layout area may be a regular shape or an irregular shape, and the specific shape and size may be designed according to actual requirements. Optionally, the regular area may be a nine-square area. In this case, the preview media content may be displayed in each square. The irregular area is a randomly generated area. In this case, the preview content is still displayed in each area, except that there is a certain difference in the area occupied by the preview content in each layout area, and the specific difference is related to the randomly generated area.

Specifically, when it is detected that a control for generating the media content is triggered, the shooting apparatus may be invoked to acquire the preview media content within the field of view based on the shooting apparatus. When the shooting apparatus is invoked, the preset page layout information may be acquired, and the preset page layout information is parsed to determine how to display the preview media content on the shooting page based on the parsed layout information and display the preview media content.

Exemplarily, referring to FIG. 2, the preset page layout information is four-square layout information, and the solution provided in this embodiment of the present disclosure corresponds to an effect prop in the application software. When it is detected that the effect prop is triggered, it is determined that the first trigger operation for generating the media content is triggered. At this time, the shooting apparatus may be enabled to acquire the preview media content within the field of view of the shooting apparatus, as shown in (a) of FIG. 2. In addition, when parsing of the preset page layout information is completed and it is determined that the four-square layout information is obtained, the preview media content may be displayed in each layout area of the four squares, to obtain the schematic diagram of the effect shown in (b) of FIG. 2.

Based on the preceding technical solution, the step of displaying the preview media content according to the preset page layout information further includes the following step: after the preset page layout information is parsed to determine at least two layout areas, resolution reduction processing may be performed on the preview media content to further improve the processing efficiency of the first media content.

Optionally, the preview media content is displayed according to a preset resolution after degradation, or an image resolution degradation rate is determined according to the number of the at least two layout areas to perform resolution reduction processing on the preview media content based on the image resolution degradation rate.

Specifically, the resolution of the preview media content after reduction may be preset, and the resolution of the preview media content is adjusted according to the resolution. Alternatively, a mapping relationship between a resolution reduction rate and the number of layout areas may be created in advance to determine the image resolution reduction rate corresponding to the at least two layout areas in the preset page layout information based on the mapping relationship. After the image resolution reduction rate is acquired, the target resolution of the preview media content may be determined based on the initial screen resolution and the image resolution degradation rate, to adjust the resolution of the preview media content based on the target resolution and display the preview media content in each layout area.

It should be noted that the resolution reduction rate and the number of layout areas are determined based on a plurality of experiments, or the mapping relationship is determined based on fitting of the number of different distribution areas and image resolutions.

Exemplarily, the preset page layout information is four-square layout information, and the resolution reduction rate corresponding to the four-square layout information is determined as 5% based on the mapping relationship. When the preview media content is acquired, the initial resolution corresponding to the preview media content may be acquired, and the initial resolution corresponding to the preview media content is reduced by 5% based on the resolution reduction rate. Certainly, the subsequent acquired preview media content is still processed based on this resolution reduction rate. The preceding image resolution reduction rate is only an example for description and does not limit the technical solution.

In this embodiment, the advantage of determining the resolution of the preview media content based on the initial resolution of the preview media content and the number of layout areas in the preset page layout information is that when the initial resolution is high, the performance of the terminal device used is high, and based on this adjustment, the effect of improving the image processing efficiency without affecting the image viewing experience may be achieved. That is, the effect of adapting to the performance of the terminal device is achieved.

S120: Replace, in response to detecting that an event of acquiring the media content is satisfied, the preview media content with acquired first media content.

In this embodiment, the event of acquiring the media content includes at least two events. Optionally, the at least two events are as follows: an event in which the shooting page is triggered and a countdown is completed; and an event in which it is determined that the event of acquiring the media content is triggered after a trigger operation for invoking a graphics library is detected to display a plurality of to-be-selected images and an image is selected by clicking from the plurality of to-be-selected images.

The first media content may be media content acquired when the event of acquiring the media content is satisfied. The first media content may be any one of an image, an audio and video, and a video.

Based on the preceding description, it may be learned that there are two trigger timings and manners of acquiring the first media content.

The first implementation is as follows: The user may click any position on the shooting page, and after the trigger operation is detected, countdown information may be displayed on a display interface, and after the countdown ends, shooting of the first media content may be automatically triggered. Optionally, the first media content is an acquired image or a recorded video. After the first media content is acquired, the preview media content may be replaced with the first media content.

The second implementation may be as follows: after it is detected that the user clicks to invoke an image library, the image library may be invoked and images in the image library are displayed on the shooting page. The image library may be an image library provided by the terminal device or a picture library that stores images in the cloud.

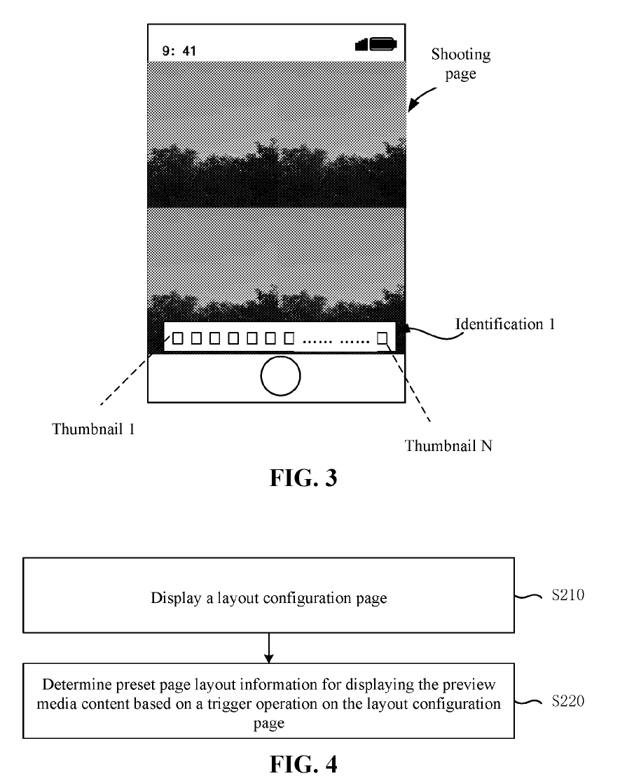

In this embodiment, the images in the image library may be displayed on the shooting page in the form of tiles, to achieve the effect of still being able to display thumbnails in the image library without affecting the preview media content, thereby facilitating selection, by the user, of the first media content from a large number of images. Referring to identification 1 in FIG. 3, the area of identification 1 displays thumbnails of respective images in the image library.

Further, the size of the display screen is fixed, and the number of displayed thumbnails is also limited. In the case where the number of images in the image library is relatively large, more images in the image library may be displayed by sliding (horizontally or vertically) the thumbnails in identification 1. After the first media content is acquired, the displayed preview media content may be replaced with the first media content.

In this embodiment, the advantage of acquiring the first media content in the preceding manner is that real-time media content may be acquired and offline media content may also be acquired, to implement a plurality of manners of acquiring the media content, thereby achieving the effect of satisfying the corresponding requirements of the user.

It should be noted that after the first media content is acquired, resolution processing may be performed on the first media content based on the resolution corresponding to the display of the preview media content. Correspondingly, the resolution corresponding to the display of the first media content is the same as the resolution corresponding to the display of the preview media content.

S130: Determine, for the at least two pieces of first media content displayed, second media content in a first style type from the first media content, and display the second media content on the shooting page.

The first style type may be a style type for makeup processing or a style type for panorama processing. In this embodiment, the style type may be configured based on actual requirements. For the at least two pieces of first media content, the corresponding style types may be the same or may be different. In order to obtain effects of the first media content in different style types, the at least two style types may be different. In other words, the style types corresponding to the second media content displayed in each layout area are different, that is, different stylized processing is performed on each piece of first media content, to obtain the second media content in different style types.

Generally, whether the first media content is an image or a video, the stylized processing may be performed on the first media content. The first media content may include a corresponding object. Optionally, the object may be a user or an animal. In the case where the first media content includes a user or an animal, some parts of the user are usually focused on after the stylized processing. Optionally, the some parts may be face parts. In this case, the stylized processing may be performed on the face parts. If a preset part is marked in advance, only the marked preset part may be stylized to obtain the media content in different style types. Correspondingly, if the style type corresponds to a makeup style, the second media content is media content in which makeup is adjusted.

In this embodiment, the media content obtained after the stylized processing is performed on the first media content is used as the second media content. Correspondingly, the presentation type of the second media content is consistent with the presentation type of the first media content, and the presentation type herein is mainly an image type or a video type.

Specifically, after the first media content is acquired, when the display duration of the first media content reaches a preset duration threshold, it may be determined that each piece of first media content is a stylized image in a corresponding style type (the first style type), and the stylized image is used as the second media content..

It should be noted that, based on the preceding descriptions, it may be learned that the shooting page includes a plurality of layout areas, and each layout area corresponds to a different style type. Correspondingly, the second media content is a processing result of the same first media content in different style types.

According to the technical solution provided in this embodiment of the present disclosure, in response to the first trigger operation for generating the media content, the preview media content may be displayed on the shooting page according to the preset page layout information. Because the preset page layout information includes a plurality of layout areas, the preview media content may be displayed in each of the plurality of layout areas. At this time, the displayed preview media content is the same. Further, when it is detected that the event of acquiring the media content is satisfied, the preview media content displayed in the layout area may be replaced with the first media content, that is, the first media content is displayed. In addition, when it is detected that a condition of displaying the second media content is satisfied, the first media content may be stylized according to the style type corresponding to each layout area in the preset page layout information, to obtain the second media content corresponding to each layout area and display the second media content. In this manner, at least two pieces of media content in style types may be displayed on the same page, thereby improving the richness of the picture content.

Generally, whether in the state of acquiring the first media content, in the state of generating the second media content, or in the process of displaying the second media content, there may be a case where the user triggers to acquire the first media data again. In this case, the media content may be re-acquired, and the second media content may continue to be generated based on the re-acquired media content, to achieve the effect of being able to display the second media content corresponding to another piece of media content without waiting for the display to be completed or exiting the effect display interface.

Optionally, the first media content is updated with acquired fifth media content in response to detecting that the event of acquiring the media content is satisfied again; and the steps of determining second media content in the at least two style types from the updated first media content and displaying the second media content on the shooting page is continuously performed.

Specifically, in the process of displaying the first media content or the second media content, if it is detected that the user triggers an operation of re-acquiring the media content, optionally, if it is detected that a shooting control on the shooting page is triggered or that a thumbnail in the suspended image library is triggered (that is, when an image displayed as identification 1 in FIG. 3 is triggered), it indicates that the event of re-acquiring the media content is triggered. Correspondingly, the re-acquired media content may be displayed on the shooting page. The media content re-selected at this time is used as the fifth media content. The fifth media content may be a video, an image, or the like.

The re-acquired fifth media content may be displayed on the shooting page in the following manner: the first media content is replaced with the fifth media content, and the replaced fifth media content is used as the first media content. Further, the subsequent steps of determining the second media content corresponding to the first media content and displaying the second media content may be continuously performed.

The advantage of adjusting the second media content in the preceding manner is that the content displayed on the shooting page may be updated based on real-time operations of the user, and the displayed content changes in a timely manner based on the trigger operation of the user, thereby improving the user experience.

FIG. 4 is a schematic flowchart of an image processing method according to an embodiment of the present disclosure. Based on the preceding embodiments, after the trigger operation for generating the media data is detected, in order to satisfy personalized display of the second media content, the page layout information for displaying the second media data may be determined based on a configuration manner. For the specific implementation, refer to the detailed description of the technical solution. The technical terms the same as or corresponding to those in the preceding embodiment are not described herein again in this embodiment.

As shown in FIG. 4, the method includes the following steps.

S210: Display a layout configuration page.

The layout configuration page is used for configuring layout information of the preview media content displayed on the shooting page. The layout configuration page includes a plurality of layout options. Optionally, the layout option corresponds to a schematic diagram corresponding to each page layout. Each layout option is used for being triggered to determine a page layout to be currently used.

A plurality of page layouts may be preset. Optionally, the page layouts correspond to a nine-square layout, a four-square layout, a pentagonal layout, a hexagonal layout, a circular layout, an elliptical layout, and the like. A schematic diagram of the page layout may be used as the content displayed on a control of the option, that is, based on the content displayed on the option, the prototype of the page layout may be preliminarily learned.

In order to achieve the effect of page layout customization, the layout configuration page further includes a custom configuration option. The custom configuration option is used for determining the page layout information based on an editing operation of the user after the custom configuration option is triggered.

Specifically, after the first trigger operation for generating the first media content is detected, a default page layout may be directly invoked and used as the preset page layout information. Certainly, after it is detected that a page layout configuration control is triggered, the layout configuration page may be displayed. Alternatively, after the first trigger operation for generating the first media content is detected, the layout configuration page may be automatically pulled up. When the layout option is not triggered within a preset duration, the default page layout information is used as the preset page layout information. Certainly, if the user triggers the layout option, the triggered and selected layout option is used as the preset page layout information.

It should be noted that the layout configuration page may be displayed when the preview media content is displayed, or the layout configuration page may be displayed in the process of displaying the preview media content based on the default page layout information (four-square page layout).

Exemplarily, referring to FIG. 5, the layout configuration page is displayed when the preview media content is displayed, so that the preview media content is displayed according to the edited preset page layout information based on the editing operation on the layout configuration page. Alternatively, after the preview media content is displayed, the default page layout information is invoked, and the layout configuration page is displayed in the process of displaying the preview media content according to the layout manner in the page layout information, to re-determine the display layout of the preview media content based on the editing operation on the layout configuration page.

S220: Determine preset page layout information for displaying the preview media content based on a trigger operation on the layout configuration page.

The user may click to select a layout option on the layout configuration page, and the page layout information corresponding to the triggered and selected layout option is used as the preset page layout information.

Based on the preceding technical solution, the method further includes the following steps: track drawing information of a contact on the shooting page is acquired in response to a trigger operation on a custom configuration option on the layout configuration page; at least two connected domains are determined based on the track information; and in response to an instruction indicating that track drawing is completed, the page layout information is determined based on the at least two connected domains and used as the preset page layout information.

When it is detected that the custom configuration option on the layout configuration page is triggered, that is, after background receives a track drawing instruction, the track drawing information of the contact on the shooting page may be acquired based on the track drawing instruction. The contact may be a touch point of a finger or a stylus on the shooting page. The number of the at least two connected domains may be two connected domains or more than two connected domains. The connected domain may be understood as a completely closed or semi-closed area, and this area may be used as a layout area. The connected domain is determined based on the track drawing information, that is, based on the track drawing information, at least two semi-closed or fully closed areas may be determined and used as the layout area in the preset page layout information.

In this embodiment, the instruction indicating that the track drawing is completed may be as follows: the track drawing duration reaches a preset duration threshold, or motion information of the contact on the shooting page is not detected within a preset duration (optionally, 3 s), or it is detected that a control indicating that the track drawing is completed is triggered.

It may be understood that when it is detected that the custom configuration option on the layout configuration page is triggered, the contact on the shooting page is acquired, the motion track of the contact on the shooting page is acquired, and the motion track is used as the track drawing information. In the process of track drawing, the at least two connected domains corresponding to the drawn track are dynamically determined. After it is detected that the track drawing is completed, the page layout information may be determined based on the at least two determined connected domains and used as the preset page layout information.

The advantage of determining the preset page layout information in the preceding manner is that the user may create the preset page layout information based on actual requirements, so that the acquired preview media content and the processed second media content satisfy the personalized requirements of the user when displayed.

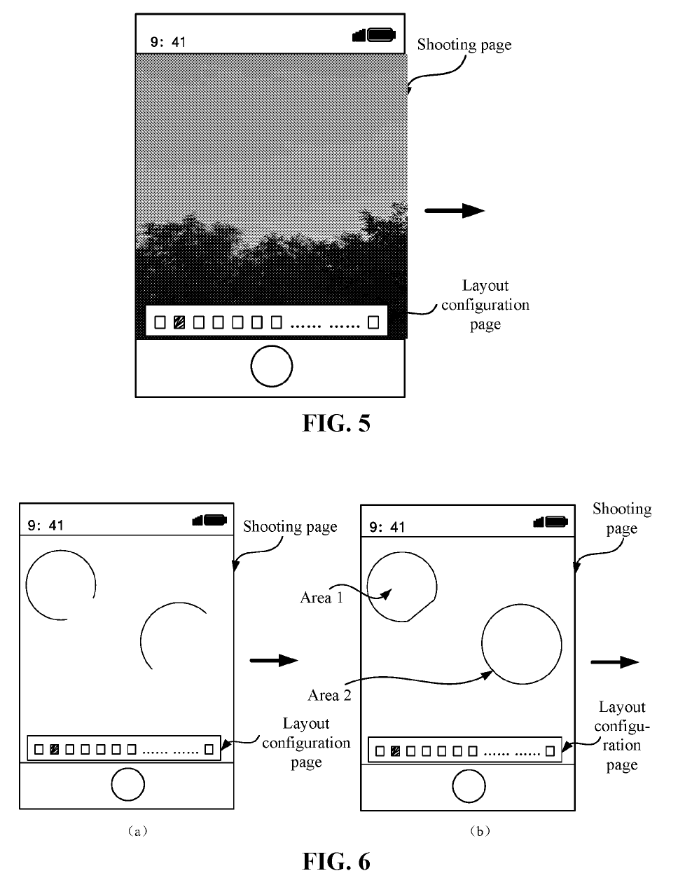

Exemplarily, referring to FIG. 6, the track drawing information of the contact on the shooting page is detected. Optionally, the track drawing information corresponds to two curves, as shown in (a) of FIG. 6. At least two areas may be determined based on the two curves, and the two areas may be marked as area 1 or area 2, as shown in (b) of FIG. 6. After the instruction indicating that the track drawing is completed is received, the layout area in the preset page layout information and the display sequence of displaying the second media content, that is, the processing sequence of processing the first media content, may be determined based on area 1 and area 2 and the time sequence of forming the two areas. It should be noted that FIG. 6 is described by using an example in which background information is hidden, and the background information is not excluded.

Based on the preceding technical solution, track drawing guidance prompt information may be displayed when the motion track is drawn based on the contact.

Optionally, prompt information for guiding track drawing is displayed at a first preset position on the shooting page. The prompt information may be text prompt information or track prompt information. Regardless of the prompt manner, the main purpose is to prompt the user to draw at least two areas to display the preview media content, the first media content, and the second media content based on the at least two areas. The first preset drawing may be any position that the user may see on the shooting page.

The text prompt information may be "Please draw at least two areas". The track prompt information may be that areas in a plurality of shapes are displayed on the shooting page, which facilitates drawing, by the user, of an area based on the areas in the plurality of shapes, that is, guides the user on how to draw an area.

When the user is prompted how to draw the track in the preceding manner, the efficiency of the user in drawing the layout area may be improved, thereby achieving the effect of interaction efficiency.

After the preset page layout information is confirmed, in order to enable the generated second media content to satisfy the effect of personalized requirements, a style type configuration interface may be set in the development stage, and a style type setting control may be set on the shooting page. Thus, the style type configuration interface is invoked based on the trigger operation on the style type setting control to retrieve the icon corresponding to the at least one style type. The style type corresponding to each layout area is determined based on the trigger operation on the displayed icon, so that the obtained second media content satisfies the personalized requirements of the user for the stylized type.

Optionally, after the preset page layout information is determined, the method further includes the following steps: a style type selection interface is displayed, wherein the style type selection interface is used for displaying icons of at least two selectable style types, and the icons are thumbnails of fourth media content of third media content in the at least two style types; and the first style type corresponding to each of the at least two layout areas is determined in response to a trigger operation on the style type selection interface.

In actual application, at least two style types corresponding to each preset page layout information may be pre-configured. When the style editing control is not triggered after the preset page layout information is determined, the at least two style types that are pre-configured and that correspond to the preset page layout information may be retrieved. At this time, the at least two style types are different.

At least two layout areas may be determined based on the preset page layout information, and there is a difference in the style type corresponding to each layout area. It may be understood that there are at least two style types in the at least two layout areas. Certainly, three layout areas may also correspond to two style types. In this case, there is a case where two layout areas correspond to one style type.

In order to enable the user to quickly determine the style type corresponding to each layout area, third media data may be acquired first. The third media data may be an image including a target object. The third media content may be the same or may be different. Stylization processing models corresponding to different style types are acquired, and the third media data is stylized based on the corresponding stylization processing models, to obtain fourth media content obtained after the third media content is stylized, that is, the fourth media content is a stylized image. This image may represent the processing effect in the style type.

For the shooting page, the displayed content is limited. In order to determine the processing effect corresponding to each style type, the thumbnail corresponding to the fourth media content may be displayed when the style type selection interface is pulled up on the shooting page. This thumbnail is used as the icon corresponding to each selectable style type. That is, the icon is mainly the thumbnail corresponding to the fourth media content. Certainly, when the number of thumbnails is greater than the number that may be displayed on the style type selection interface, the icons corresponding to more style types may be displayed based on the slide operation on the style type selection interface.

It should be noted that the preset page layout information further includes the display sequence corresponding to each layout area. Therefore, the style type selected by clicking for the first time is determined as the style type corresponding to the first layout area. Certainly, if a double-click operation is performed on a style type, it indicates that the selection of the style type needs to be cancelled.

Specifically, after the preset page layout information is determined, the plurality of layout areas and the display sequence of the second media content corresponding to each layout area may be determined. At this time, if the personalized presentation of the second media content needs to be achieved, the style type setting control may be triggered to display the style type selection page based on the trigger operation on the style type setting control. The icons corresponding to the plurality of selectable style types may be displayed on the style type selection page, and the icons are mainly the thumbnails of the fourth media content obtained after different style types act on the third media content. Based on the set thumbnails, the action effect of each selectable style type may be determined. When it is detected that the user clicks on a selectable style type for the first time, the clicked selectable style type is used as the first style type corresponding to the layout area whose display sequence is the first. If the selectable style type is double-clicked, the selection of the selectable style is cancelled. After the first style type of a selectable layout area is selected, if it is detected that the layout area is selected again, the first style type may be re-selected for the layout area.

It should be noted that, in order to achieve the effect that there is a difference in the style type corresponding to the second media content, the selected first style type may be recorded based on the click operation of the user on the selectable style type in the process of clicking on the selectable style type. If the first style type is selected multiple times, the prompt information may be popped up, or the selected first style type is grayed out on the style type selection interface, that is, the selectable style type that has been selected cannot be selected again. Based on this manner, the effect that there is a difference in the first style type selected in each layout area may be achieved.

Optionally, a selectable style type triggered and selected based on a trigger operation on the selectable style type on the style type selection interface is used as the first style type, and the selectable style type triggered and selected is displayed in a first preset form on the style type selection interface, wherein the first preset form is used for representing a state in which the selectable style type cannot be triggered and selected again.

The advantage of selecting the first style type in the preceding manner is that the user may be facilitated to know which selectable style types have been selected in a timely manner, thereby avoiding the problem that the richness of the picture content is relatively single caused by the user selecting again.

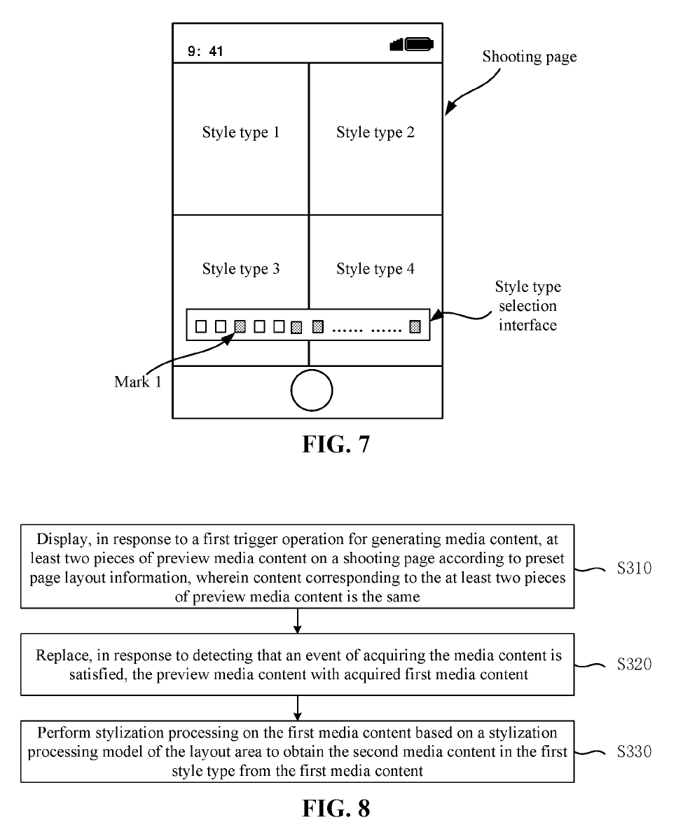

Exemplarily, the style type selection interface may be displayed on the shooting page. At this time, the preview media content displayed on the shooting page may be the default page layout, or may be displayed based on the layout area in the preset page layout. Here, an example in which the preview media content is displayed in the form of preset four-square layout information is used for description. As shown in FIG. 7, the icons corresponding to the plurality of selectable style types may be displayed on the style type selection interface. The first style type of the layout area is determined based on the selected icon. In addition, the icon of the selectable style type that has been selected is in the first preset form. Optionally, the first preset form is a grayed out state, as shown in identification 1 in FIG. 7.

According to the technical solution provided in this embodiment of the present disclosure, the page layout information for displaying the preview media content, the first media content, and the second media content is determined based on the editing operation on the layout configuration page. At this time, the effect of personalized selection of the page layout may be achieved. Further, whether the preset page layout is personalized or the preset page layout is default, the corresponding style type may be configured for each layout area in the preset page layout based on this, to display, in different layout areas, the second media content of the first media content in different first style types, thereby achieving the effects of customized and personalized display of the second media content and diversity of interaction.

FIG. 8 is a schematic flowchart of a media content generation method according to an embodiment of the present disclosure. It may be learned based on the preceding embodiments that the preset page layout information includes at least one layout area, and there is a certain difference in the first style type corresponding to the at least one layout area. Based on this, after the first media content is acquired, the second media content of the first media content in each layout area in the corresponding style type may be determined. At this time, the style types corresponding to the second media content displayed on the shooting page are different, thereby achieving the effect of enriching the picture content. For the specific implementation, refer to the detailed description of this embodiment. The technical terms the same as or corresponding to those in the preceding embodiments are not described herein again in this embodiment.

As shown in FIG. 8, the method provided in this embodiment of the present disclosure includes the following steps.

S310: Display, in response to a first trigger operation for generating media content at least two pieces of preview media content on a shooting page according to preset page layout information, wherein content corresponding to the at least two pieces of preview media content is the same.

It may be understood that when it is detected that a control for generating the media content is triggered, a shooting apparatus may be enabled to acquire preview media content within the field of view. In addition, the set preset page layout information may be acquired, to simultaneously display a plurality of pieces of preview media content on the shooting page based on the preset page layout information.

It should be noted that the preview media content displayed on the shooting page is acquired based on a same shooting apparatus, and therefore, the preview media content is the same.

It should be further noted that the shooting apparatus is deployed in the terminal device, and the displayed preview media content mainly depends on the content that may be captured by the shooting apparatus in the process of the terminal device moving. In addition, before the event of acquiring the media content is satisfied, the shooting page may continuously output (display) the preview media content.

S320: Replace, in response to detecting that an event of acquiring the media content is satisfied, the preview media content with acquired first media content.

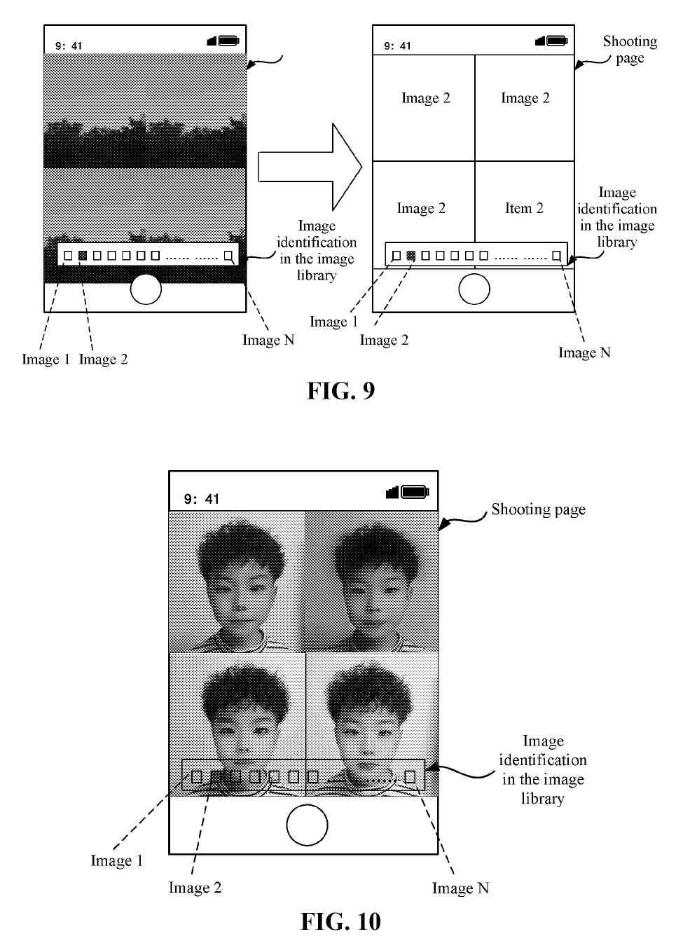

Exemplarily, referring to FIG. 9, after the preset page layout information is determined, the first media content may be acquired. Optionally, the first media content is selected based on a trigger operation on an image identification of a certain image in an image library, and the first media content corresponding to the selected image identification may be displayed based on the preset page layout information (four-square layout information). At this time, the preview media content may be replaced with the first media content. That is, an identification of image 2 is triggered, and the preview media content may be replaced with image 2. At this time, image 2 is the acquired first media content.

S330: Perform stylization processing on the first media content based on a stylization processing model of the layout area to obtain the second media content in the first style type from the first media content.

Each style type corresponds to a stylization processing model. The stylization processing model is a model obtained through training in advance based on a training sample. Optionally, the stylization processing model is an ancient-style makeup processing model, a sweet-style makeup processing model, or the like. The specific model training manner is not limited in this embodiment, and any existing model that may perform effect processing may be acquired. That is, all selectable style types open in the development stage correspond to corresponding stylization processing models.

The stylization processing may be understood as that the first media content is input into the stylization processing model, and the stylization processing model may output the media content obtained after the stylization processing is performed on the first media content and use the media content as the second media content.

It should be noted that the first style type corresponding to each layout area is different, and the first media content may be processed based on the stylization processing model corresponding to each layout area, to obtain the second media content displayed in the layout area.

It may be learned based on the preceding descriptions that the stylization processing may be simultaneously performed on the first media content based on the stylization processing model corresponding to each layout area, to obtain the second media content of each layout area.

Exemplarily, the preset page layout information is four-square layout information, and for the schematic diagram of the effect of the second media content corresponding to each layout area obtained after the first media content is processed, refer to FIG. 10. It may be learned based on FIG. 10 that there is a certain difference in the second media content corresponding to each layout area, and the difference is mainly reflected in the style type. The style type at this time is mainly the makeup style type.

In actual application, there may be a case where a terminal device used by some users has a high performance and may support parallel processing to obtain the second media content. Certainly, there may also be a case where the terminal device has a high performance but cannot support parallel processing to obtain the second media content. Based on this, the following manner may be used for determining how to perform stylization processing on the first media content based on the stylization processing model corresponding to each layout area. This is also because each stylization processing model incurs a large device overhead, and therefore, the second media content may be determined in the following manner.

It should be noted that the fact that parallel processing is not supported is mainly reflected in the occurrence of image freezes and/or flashbacks in the parallel processing process.

In this embodiment, the steps of determining the second media content in the at least two style types from the first media content includes the following steps: a display sequence of the second media content corresponding to the at least two layout areas in the preset page layout information is acquired; and when it is detected that the second media content of the first media content is output based on the stylization processing model of the layout area, the stylization processing model of a next layout area is enabled based on the display sequence to process the first media content until the second media content corresponding to a last layout area is output.

The preset page layout information includes at least two layout areas and the display sequence of each layout area when the second media content is displayed. The stylization processing model of each layout area may be enabled to process the first media content in sequence based on the display sequence. At this time, it may be implemented that only one stylization processing model is running at a moment, thereby avoiding the problem of high requirements on the device performance when a plurality of stylization processing models are running simultaneously.

Specifically, the display sequence corresponding to each layout area in the preset page layout information is acquired. The running sequence of the stylization processing models corresponding to the layout area may be determined based on the display sequence. In actual application, when an output result of an ith stylization processing model is detected, the ith stylization processing model may be closed. An (i+1)th stylization processing model is invoked, and the first media content is processed based on the (i+1)th stylization processing model.

It should be noted that based on the preceding manner, the case where only one algorithm (stylization processing model) is running at the same moment may be implemented, thereby reducing the requirements on the device performance, that is, achieving the effect of optimization in terms of the frame rate. Further, in terms of the memory, because the preset page layout information includes a plurality of layout areas, and the first media content displayed in each layout area is an image after resolution reduction processing, that is, the single-screen image is an image obtained after the resolution is reduced, the reduction in the resolution has no impact on the visual effect, and for the algorithm (stylization processing model), both the resolution of the input image and the resolution of the rendered texture are appropriately reduced, thereby achieving the effect of saving memory.

Generally, there is a certain difference in the performance of each terminal device. In order to achieve the effect that the stylization processing model is adapted to the terminal device, the stylization processing model corresponding to each terminal device may be determined based on the device performance, to improve the efficiency of the terminal device in generating the second media content.

Optionally, the style type corresponding to the layout area and a device performance parameter are sent to a first server, to enable the first server to deliver a stylization processing model corresponding to the style type based on the device performance parameter, to process the first media content into the second media content corresponding to the style type based on the stylization processing model, wherein the device corresponding to the device performance parameter is a device that performs displaying of the second media content.

The first server is a server that analyzes and processes data to determine delivered data. The device performance parameter may be a hardware parameter of the mobile terminal, optionally, a running memory, a running kernel, or the like. Each style type has a type identification, and the type identification of the style type and the device performance parameter may be sent to the first server.

Specifically, after the style type is determined, the style type and the device performance parameter may be sent to the first server together. After receiving the style type and the device performance parameter, the first server may determine, based on the device performance parameter, the device performance of the terminal device running the solution provided in this embodiment of the present disclosure. The level of the delivered stylization processing model may be determined based on the device performance. Different-level stylization processing models of a same style type correspond to a same stylization effect, and the difference lies in the fineness after the stylization processing. Generally, a stylization processing model with a higher level corresponds to a larger model parameter, and has higher requirements on the device performance. After the device performance is determined, the level of the stylization processing model adapted to the device performance may be determined based on the range in which the device performance is located. The stylization processing model adapted to the level is invoked and delivered to the client. After the stylization processing model is received, the stylization processing model corresponding to each layout area may be controlled, in the preceding mentioned manner, to perform stylization processing on the first media data, to obtain the second media content corresponding to each layout area.

According to the technical solution provided in this embodiment of the present disclosure, the stylization processing is performed on the first media content based on the stylization processing model corresponding to each layout area, a plurality of pieces of second media content in different style types may be obtained, and the second media content in each style type is sequentially displayed on the same shooting page based on the display sequence, that is, the effect of displaying, on the same shooting page, the second media content in a plurality of style types to improve the richness of the picture content is achieved. Further, when the stylization model in the style type is determined based on the performance parameter of the terminal device, the stylization model may be adapted to the terminal device, thereby achieving the effect of improving the processing efficiency.

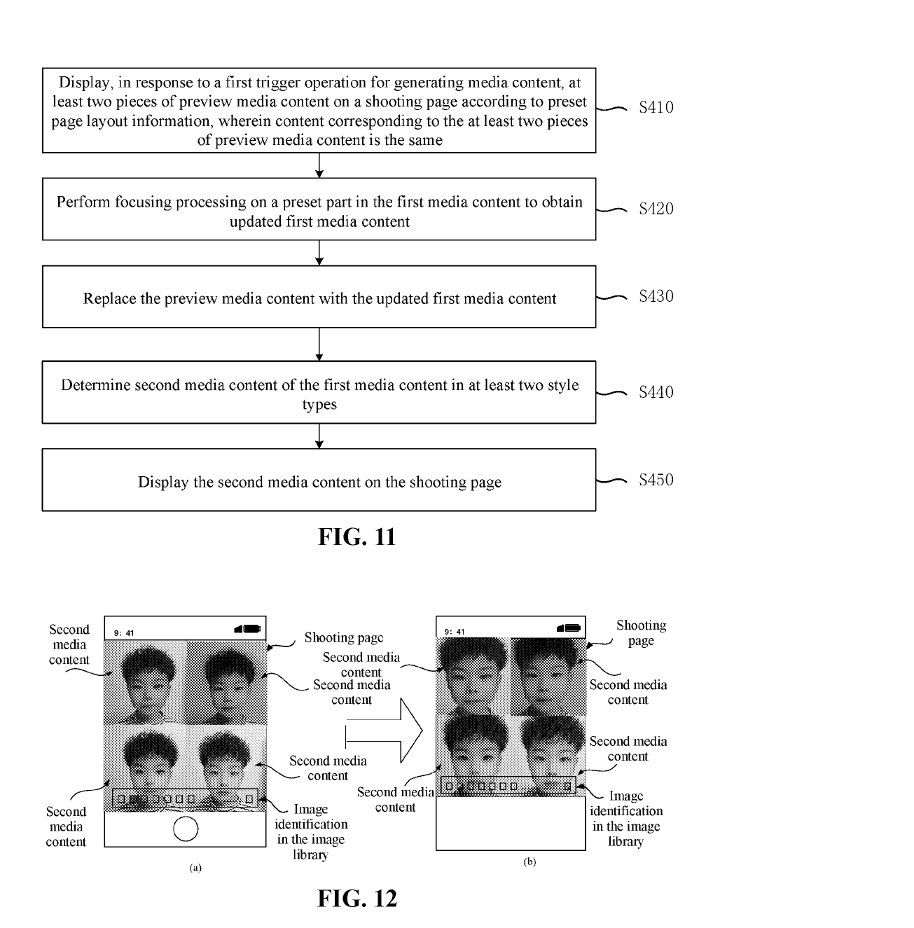

FIG. 11 is a schematic flowchart of a media content generation method according to an embodiment of the present disclosure. When the second media content is displayed, the user may most concern the area in which the stylization processing is performed. At this time, in order to achieve the effect that the part in which the stylization processing is performed is highlighted, after the first media content is acquired, the preset part in which the stylization processing is performed in the first media content is amplified to update the first media data displayed on the shooting page, so that the stylization effect of the preset part in the second media content is more clearly displayed. For the specific implementation, refer to the detailed description of this embodiment. The technical terms the same as or corresponding to those in the preceding embodiments are not described herein again in this embodiment.

As shown in FIG. 11, the method provided in this embodiment of the present disclosure includes the following steps.

S410: Display, in response to a first trigger operation for generating media content, at least two pieces of preview media content on a shooting page according to preset page layout information, wherein content corresponding to the at least two pieces of preview media content is the same.

S420: Perform focusing processing on a preset part in the first media content to obtain updated first media content.

The preset part may be a preset face part. Correspondingly, the first style type may be a model for performing stylized processing on the face part. Optionally, the focusing processing may be extracting key points of the face part, amplifying a face image based on the key points, and using the face part obtained after the amplifying as the updated first media content.

Specifically, after the first media content is displayed, focusing processing is performed on a face feature in the first media content based on a face focusing algorithm, to obtain the first media content in which the face feature is amplified.

That is, in this embodiment, the acquired first media content needs to be subjected to focusing processing on the preset part, that is, subjected to effect processing of face amplification, and then used as the input of the stylization processing model, to obtain the second media content after the stylization processing.

S430: Replace the preview media content with the updated first media content.

S440: Determine second media content of the first media content in at least two style types.

S450: Display the second media content on the shooting page.

Exemplarily, if focusing processing is not performed on the preset part, the generated second media content is shown in (a) of FIG. 12, and if focusing processing is performed on the preset part, the generated second media content may be shown in (b) of FIG. 12. It may be learned based on the two images that the second media content after the focusing processing may better highlight the preset part, thereby achieving the effect of displaying the preset part with high definition.

It may be learned based on the preceding descriptions that the first media content is processed in the manner of focusing on and following the preset part. Because the face part is displayed in a multi-screen manner on the shooting interface, the perception of the change before and after the effect is not very obvious. Therefore, the effect of face focusing is added, so that the viewing user may clearly perceive the change in the face part.

According to the technical solution provided in this embodiment of the present disclosure, through focusing processing on the preset part, the preset part in the first media content may be amplified. After the stylized second media content is determined based on the first media content obtained after the amplifying, the change information of the second media content relative to the first media content may be clearly seen, thereby improving the effect of displaying the change from the first media content to the second media content with high definition.

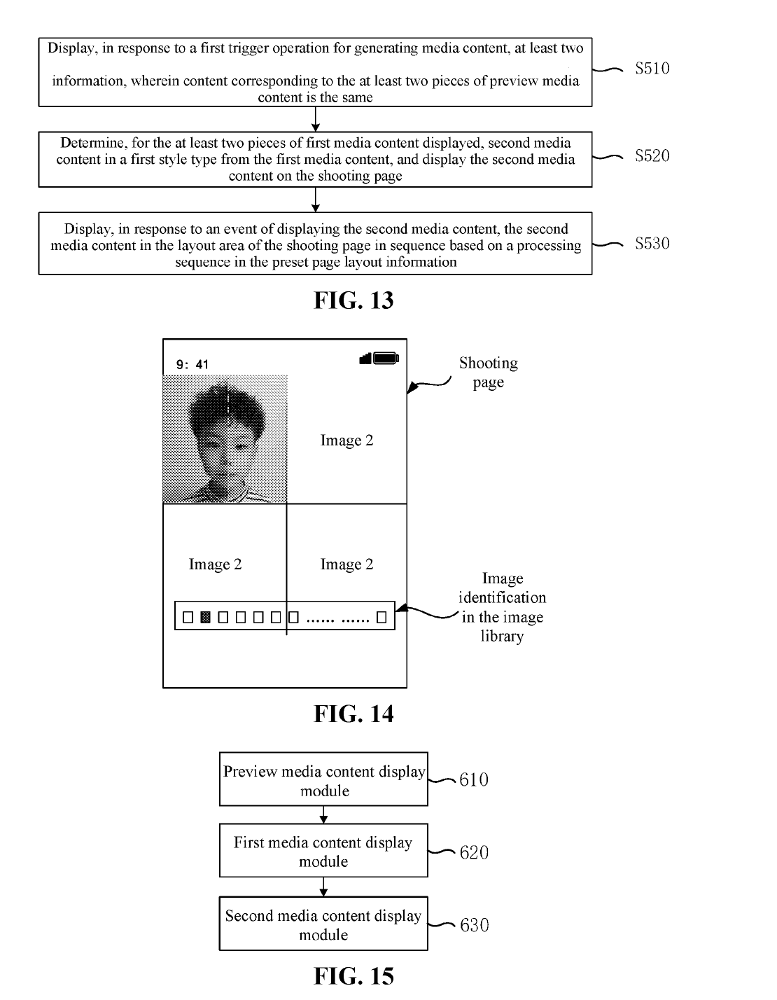

FIG. 13 is a schematic flowchart of a media content generation method according to an embodiment of the present disclosure. In order to create the effect that the second media data is displayed while being rendered, the rendered second media content may be displayed based on the display sequence of the second media content in each layout area in the preset page layout information. For the specific implementation, refer to the detailed description of this embodiment. The technical terms the same as or corresponding to those in the preceding embodiments are not described herein again in this embodiment.

As shown in FIG. 13, the method includes the following steps.

S510: Display, in response to a first trigger operation for generating media content, at least two pieces of preview media content on a shooting page according to preset page layout information, wherein content corresponding to the at least two pieces of preview media content is the same.

S520: Determine, for the at least two pieces of first media content displayed, second media content in a first style type from the first media content, and display the second media content on the shooting page.

S530: Display, in response to an event of displaying the second media content, the second media content in the layout area of the shooting page in sequence based on a processing sequence in the preset page layout information.

The event of displaying the second media content may be an event of generating the second media content in a first layout area, or an event in which it is detected that the duration of generating the second media content reaches a preset duration threshold. The processing sequence may be the sequence in which the stylization processing model of the page layout area performs stylization processing on the first media content. The processing sequence corresponds to the display sequence, and is the sequence of first processing and then displaying.

Specifically, when it is detected that the event of displaying the second media content is satisfied, the second media content may be sequentially displayed on the shooting page based on the processing sequence in the page layout information.

It should be noted that because the second media content is sequentially displayed, and the processing moment of the first media content based on the stylization model is earlier than the display moment of the second media content, when the second media content is displayed, the stylization processing model of the next layout area may continue to process the first media content in the background to obtain the second media content, and when it is detected that the second media content in the layout area satisfies display, the second media content may be displayed. That is, each stylization processing model may complete the processing before the second media content corresponding to the layout area is displayed, that is, the display result is advanced by a certain duration, thereby avoiding the effect that a long waiting time of the user affects the user experience.

Based on the preceding technical solution, for the second media content in the layout area, the displayed first media content transitions to the second media content according to a preset transition manner.

The preset transition manner may be a manner of sliding based on a line to reflect the transition from the first media content to the second media content. The line may slide horizontally, that is, slide from left to right for display. In actual application, the transition manner may be set based on the actual requirements, and the specific transition manner is not limited in this embodiment.

Exemplarily, referring to FIG. 14, the preset transition manner is horizontal transition from left to right. In the transition process, the content presented by the images in other distribution areas is the first media content, that is, image 2. The left side of the line shows the stylized effect, and the right side of the line shows the non-stylized effect. The transition from the first media content to the second media content is presented in the manner of horizontal transition. The advantage of this manner is that the changed content may be determined in a timely and accurate manner, thereby improving the effect of timely understanding of the content.

According to the technical solution provided in this embodiment of the present disclosure, after the second media content corresponding to the at least one layout area is determined, the second media content may be sequentially displayed. Because the moment of generating the second media content is earlier than the display moment of the second media content, the effect of smoothly displaying the second media content may be achieved when the second media content is displayed.

FIG. 15 is a schematic diagram of a structure of a media content generation apparatus according to an embodiment of the present disclosure. The apparatus includes a preview media content display module 610, a first media content display module 620, and a second media content display module 630.

The preview media content display module 610 is configured to display, in response to a first trigger operation for generating media content, at least two pieces of preview media content on a shooting page according to preset page layout information, wherein content corresponding to the at least two pieces of preview media content is the same; the first media content display module 620 is configured to replace, in response to detecting that an event of acquiring the media content is satisfied, the preview media content with acquired first media content; and the second media content display module 630 is configured to determine, for the at least two pieces of first media content displayed, second media content in a first style type from the first media content, and display the second media content on the shooting page, wherein content of the at least two pieces of first media content is the same, style types of the second media content corresponding to the at least two pieces of first media content are different, and type information of the style types is related to the preset page layout information.

According to the technical solution provided in this embodiment of the present disclosure, in response to the first trigger operation for generating the media content, the preview media content may be displayed on the shooting page according to the preset page layout information. Because the preset page layout information includes a plurality of layout areas, the preview media content may be displayed in each of the plurality of layout areas. At this time, the displayed preview media content is the same. Further, when it is detected that the event of acquiring the media content is satisfied, the preview media content displayed in the layout area may be replaced with the first media content, that is, the first media content is displayed. In addition, when it is detected that a condition of displaying the second media content is satisfied, the first media content may be stylized according to the style type corresponding to each layout area in the preset page layout information, to obtain the second media content corresponding to each layout area and display the second media content. In this manner, at least two pieces of media content in style types may be displayed on the same page, thereby improving the richness of the picture content.

Based on the preceding technical solution, the apparatus further includes:

a layout configuration page display module configured to display a layout configuration page, wherein the layout configuration page is used for configuring layout information of the preview media content displayed on the shooting page; and

a layout information configuration module configured to determine preset page layout information for displaying the preview media content based on a trigger operation on the layout configuration page.

Based on the preceding technical solution, the preset page layout information includes at least two layout areas, and the apparatus further includes a style type display module and a style type determination module.

The style type display module is configured to display a style type selection interface, wherein the style type selection interface is used for displaying icons of at least two selectable style types, and the icons are thumbnails of fourth media content of third media content in the at least two style types.

The style type determination module is configured to determine the first style types corresponding to the at least two layout areas, respectively, in response to a trigger operation in the style type selection interface.

On the basis of the preceding technical solution, the preset page layout information includes at least two layout areas and the second media content display module is further configured to:

perform, for each of the at least two layout areas, stylized processing on the first media content according to a stylization processing model of the layout area to obtain the second media content of the first media content under the first style type.

On the basis of the preceding technical solution, the second media content display module is further configured to:

acquire a display sequence of the second media content corresponding to the at least two layout areas in the preset page layout information; and

enable a stylization processing model of a next layout area to process the first media content based on the display sequence when it is detected that the second media content of the first media content is output based on the stylization processing model of the layout area, until second media content corresponding to a last layout area is output.

Based on the preceding technical solution, the stylization processing model corresponding to the at least one layout area is determined based on the following manner:

sending a style type corresponding to the layout area and a device performance parameter to a first server;

determining a model level corresponding to the device performance parameter based on analysis and processing of the device performance parameter by the first server; and

determining a stylization processing model to be delivered based on the model level and the style type,

where a device corresponding to the device performance parameter is a device that performs displaying of the second media content.

Based on each of the preceding technical solutions, the apparatus further includes a first media content adjustment module and a first media content display module.

The first media content adjustment module is configured to perform focusing processing on a preset part in the first media content to obtain updated first media content.

The first media content display module is configured to replace the preview media content with the updated first media content.

Based on each of the preceding technical solutions, the second media content display module is further configured to:

display, in response to an event of displaying the second media content, the second media content in sequence on the shooting page according to a processing sequence in the preset page layout information.

Based on each of the preceding technical solutions, the second media content display module is further configured to:

for the second media content in a layout area, transition from the displayed first media content to the second media content according to a preset transition manner.

Based on each of the preceding technical solutions, the second media content display module is further configured to include a content acquisition unit and a continued execution unit.

The content acquisition unit is configured to update, in response to detecting that an event of acquiring the media content is satisfied again, the first media content with acquired fifth media content.

The continued execution unit is configured to continue to perform the steps of determining second media content in the at least two style types from the updated first media content and displaying the second media content on the shooting page.

According to the technical solution provided in this embodiment of the present disclosure, in response to the first trigger operation for generating the media content, the preview media content may be displayed on the shooting page according to the preset page layout information. Because the preset page layout information includes a plurality of layout areas, the preview media content may be displayed in each of the plurality of layout areas. At this time, the displayed preview media content is the same. Further, when it is detected that the event of acquiring the media content is satisfied, the preview media content displayed in the layout area may be replaced with the first media content, that is, the first media content is displayed. In addition, when it is detected that a condition of displaying the second media content is satisfied, the first media content may be stylized according to the style type corresponding to each layout area in the preset page layout information, to obtain the second media content corresponding to each layout area and display the second media content. In this manner, at least two pieces of media content in style types may be displayed on the same page, thereby improving the richness of the picture content.

The data pre-detection apparatus provided in this embodiment of the present disclosure may perform the media content generation method provided in any embodiment of the present disclosure, and has corresponding functional modules and beneficial effects for performing the method.

It is worth noting that the units and modules included in the preceding apparatus are just divided according to functional logic but are not limited to such division, as long as the corresponding functions may be implemented. In addition, the specific names of the functional units are just for distinguishing between each other but not to limit the protection scope of the embodiments of the present disclosure.

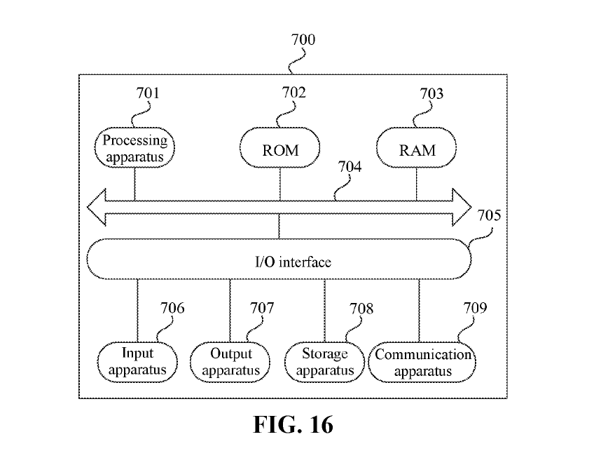

FIG. 16 is a schematic diagram of a structure of an electronic device according to an embodiment of the present disclosure. As shown in FIG. 16, the electronic device 700 may include a processing apparatus (such as a central processing unit and a graphics processing unit) 701, which may perform various appropriate actions and processing according to a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are interconnected by means of a bus 704. An input/output (I/O) interface 705 is also connected to the bus 704.

Usually, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard disk; and a communication apparatus 709. The communication apparatus 709 may allow the electronic device 700 to perform wireless or wired communication with other devices to exchange data. Although FIG. 16 shows the electronic device 700 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, this embodiment of the present disclosure includes a computer program product, including a computer program carried on a non-transitory computer-readable medium, wherein the computer program includes program code for performing the method shown in the flowchart. In such an embodiment, the computer program may be downloaded from a network and installed through the communication apparatus 709, or may be installed from the storage apparatus 708, or may be installed from the ROM 702. When the computer program is executed by the processing apparatus 701, the preceding functions limited in the method in this embodiment of the present disclosure are performed.

The names of messages or information exchanged between a plurality of apparatuses in the implementations of the present disclosure are only for illustrative purposes and are not intended to limit the scope of these messages or information.

The electronic device provided in this embodiment of the present disclosure belongs to the same inventive concept as the media content generation method provided in the preceding embodiment. For technical details not described in detail in this embodiment of the present disclosure, reference may be made to the preceding embodiment, and this embodiment has the same beneficial effects as the preceding embodiment.

An embodiment of the present disclosure provides a computer storage medium, having a computer program stored thereon. When the program is executed by a processor, the media content generation method provided in any one of the preceding embodiments is implemented.

It should be noted that the computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in conjunction with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in a plurality of forms and includes, but is not limited to, an electromagnetic signal, an optical signal, or any suitable combination thereof. The computer-readable signal medium may alternatively be any computer-readable medium other than the computer-readable storage medium, and the computer-readable signal medium may send, propagate, or transmit a program used by or in conjunction with an instruction execution system, apparatus, or device. The program code included in the computer-readable medium may be transmitted in any suitable medium, including but not limited to a wire, an optical cable, a radio frequency (RF), or any suitable combination thereof.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be included in the electronic device or may exist alone without being assembled into the electronic device.

The computer-readable medium carries one or more programs, which, when executed by the electronic device, cause the electronic device to perform the following operations:

displaying, in response to a first trigger operation for generating media content, at least two pieces of preview media content on a shooting page according to preset page layout information, wherein content corresponding to the at least two pieces of preview media content is the same;

replacing, in response to detecting that an event of acquiring the media content is satisfied, the preview media content with acquired first media content; and

determining, for the at least two pieces of first media content displayed, second media content in a first style type from the first media content, and displaying the second media content on the shooting page,

where content of the at least two pieces of first media content is the same, style types of the second media content corresponding to the at least two pieces of first media content are different, and type information of the style types is related to the preset page layout information.

The computer program code for performing the operations in the present disclosure may be written in one or more programming languages or a combination thereof, wherein the programming languages include, but are not limited to, an object-oriented programming language, such as Java, Smalltalk, and C++, and further include conventional procedural programming languages, such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented in a software manner or a hardware manner. The name of a unit does not constitute a limitation on the unit itself under certain circumstances. For example, the first acquisition unit may also be described as "a unit for acquiring at least two Internet Protocol addresses".

The functions described above herein may be performed at least partially by one or more hardware logic components. For example, without limitation, exemplary types of the hardware logic components that may be used include a field programmable gate array (FPGA), an application specific integrated circuit (ASIC), an application specific standard product (ASSP), a system on chip (SOC), and a complex programmable logical device (CPLD), etc.

In the context of the present disclosure, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The preceding description is merely the illustration of the preferred embodiments of the present disclosure and the explanation of the technical principles employed. Those skilled in the art should understand that the scope of disclosure involved in the present disclosure is not limited to the technical solution formed by the specific combination of the preceding technical features, and should also cover other technical solutions formed by any combination of the preceding technical features or equivalent features thereof without departing from the preceding concept of disclosure. For example, the preceding features and the technical features disclosed in the present disclosure (but not limited to) with similar functions may be replaced each other to form a technical solution.

In addition, although the operations are depicted in a specific order, this should not be understood as requiring the operations to be performed in the specific order shown or in a sequential order. Under certain circumstances, multitasking and parallel processing may be advantageous. Similarly, although several specific implementation details are included in the preceding discussions, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combinations.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms for implementing the claims.

We claim:

1. A media content generation method, comprising:
displaying, in response to a first trigger operation for generating media content, at least two pieces of preview media content on a shooting page according to preset page layout information, wherein content corresponding to the at least two pieces of preview media content is the same;
replacing, in response to detecting that an event of acquiring the media content is satisfied, the preview media content with acquired first media content; and
determining, for the at least two pieces of first media content displayed, second media content in a first style type from the first media content, and displaying the second media content on the shooting page,
wherein content of the at least two pieces of first media content is the same, style types of the second media content corresponding to the at least two pieces of first media content are different, and type information of the style types is related to the preset page layout information.

2. The method of claim 1, wherein in response to the first trigger operation for generating the media content, the method further comprises:
displaying a layout configuration page, wherein the layout configuration page is used for configuring layout information of the preview media content when the preview media content is displayed on the shooting page; and
determining the preset page layout information for displaying the preview media content based on a trigger operation on the layout configuration page.

3. The method of claim 2, wherein determining the preset page layout information for displaying the preview media content based on the trigger operation on the layout configuration page comprises:
acquiring track drawing information of a contact on the shooting page based on a trigger operation on a preset control on the layout configuration page; and
determining, in response to an instruction indicating that track drawing is completed, at least two areas based on the track drawing information, and determining the preset page layout information for displaying the preview media content based on area information of the at least two areas.

4. The method of claim 1, wherein the preset page layout information comprises at least two layout areas, and the method further comprises:
displaying a style type selection interface, wherein the style type selection interface is used for displaying icons of at least two selectable style types, and the icons are thumbnails of fourth media content obtained after the at least two style types are applied to third media content; and
determining, in response to a trigger operation on the style type selection interface, the first style type corresponding to each of the at least two layout areas.

5. The method of claim 1, wherein the preset page layout information comprises at least two layout areas, and determining the second media content in the first style type from the first media content comprises:
performing, for the at least two layout areas, stylization processing on the first media content according to a stylization processing model of the layout area to obtain the second media content in the first style type from the first media content.

6. The method of claim 1, wherein determining the second media content in the first style type from the first media content comprises:
obtaining a display sequence of the second media content corresponding to the at least two layout areas in the preset page layout information; and
enabling, in response to detecting that the second media content of the first media content is output based on the stylization processing model of the layout area, a stylization processing model of a next layout area based on the display sequence to process the first media content, until the second media content corresponding to a last layout area is output.

7. The method of claim 5, wherein the stylization processing model corresponding to the at least one layout area is determined by:
sending a style type corresponding to the layout area and a device performance parameter to a first server;
determining a model level corresponding to the device performance parameter based on analysis and processing of the device performance parameter by the first server; and
determining a stylization processing model to be delivered based on the model level and the style type,
wherein a device corresponding to the device performance parameter is a device that performs displaying of the second media content.

8. The method of claim 1, wherein after replacing the preview media content with the acquired first media content, the method further comprises:
performing focusing processing on a preset part in the first media content to obtain updated first media content; and
replacing the preview media content with the updated first media content.

9. The method of claim 1, wherein displaying the second media content on the shooting page comprises:
displaying, in response to an event of displaying the second media content, the second media content in sequence on the shooting page according to a processing sequence in the preset page layout information.

10. The method of claim 9, wherein displaying the second media content in sequence on the shooting page comprises:
transitioning, for second media content in a layout area, from the displayed first media content to the second media content according to a preset transition manner.

11. The method of claim 1, further comprising:
updating, in response to detecting that an event of acquiring the media content is satisfied again, the first media content with acquired fifth media content; and
continuing to perform the steps of determining second media content in the at least two style types from the updated first media content and displaying the second media content on the shooting page.

12. An electronic device, comprising:
one or more processors; and
a storage apparatus configured to store one or more programs,
wherein the one or more programs, when executed by the one or more processors, cause the one or more processors to implement a media content generation method comprising:
displaying, in response to a first trigger operation for generating media content, at least two pieces of preview media content on a shooting page according to preset page layout information, wherein content corresponding to the at least two pieces of preview media content is the same;
replacing, in response to detecting that an event of acquiring the media content is satisfied, the preview media content with acquired first media content; and
determining, for the at least two pieces of first media content displayed, second media content in a first style type from the first media content, and displaying the second media content on the shooting page,
wherein content of the at least two pieces of first media content is the same, style types of the second media content corresponding to the at least two pieces of first media content are different, and type information of the style types is related to the preset page layout information.

13. The electronic device of claim 12, wherein in response to the first trigger operation for generating the media content, the method further comprises:
displaying a layout configuration page, wherein the layout configuration page is used for configuring layout information of the preview media content when the preview media content is displayed on the shooting page; and
determining the preset page layout information for displaying the preview media content based on a trigger operation on the layout configuration page.

14. The electronic device of claim 13, wherein determining the preset page layout information for displaying the preview media content based on the trigger operation on the layout configuration page comprises:
acquiring track drawing information of a contact on the shooting page based on a trigger operation on a preset control on the layout configuration page; and
determining, in response to an instruction indicating that track drawing is completed, at least two areas based on the track drawing information, and determining the preset page layout information for displaying the preview media content based on area information of the at least two areas.

15. The electronic device of claim 12, wherein the preset page layout information comprises at least two layout areas, and the method further comprises:
displaying a style type selection interface, wherein the style type selection interface is used for displaying icons of at least two selectable style types, and the icons are thumbnails of fourth media content obtained after the at least two style types are applied to third media content; and
determining, in response to a trigger operation on the style type selection interface, the first style type corresponding to each of the at least two layout areas.

16. The electronic device of claim 12, wherein the preset page layout information comprises at least two layout areas, and determining the second media content in the first style type from the first media content comprises:
performing, for the at least two layout areas, stylization processing on the first media content according to a stylization processing model of the layout area to obtain the second media content in the first style type from the first media content.

17. The electronic device of claim 12, wherein determining the second media content in the first style type from the first media content comprises:
obtaining a display sequence of the second media content corresponding to the at least two layout areas in the preset page layout information; and
enabling, in response to detecting that the second media content of the first media content is output based on the stylization processing model of the layout area, a stylization processing model of a next layout area based on the display sequence to process the first media content, until the second media content corresponding to a last layout area is output.

18. The electronic device of claim 16, wherein the stylization processing model corresponding to the at least one layout area is determined by:
sending a style type corresponding to the layout area and a device performance parameter to a first server;
determining a model level corresponding to the device performance parameter based on analysis and processing of the device performance parameter by the first server; and
determining a stylization processing model to be delivered based on the model level and the style type,
wherein a device corresponding to the device performance parameter is a device that performs displaying of the second media content.

19. The electronic device of claim 12, wherein after replacing the preview media content with the acquired first media content, the method further comprises:
performing focusing processing on a preset part in the first media content to obtain updated first media content; and
replacing the preview media content with the updated first media content.

20. A non-transitory storage medium comprising computer-executable instructions, wherein the computer-executable instructions, when executed by a computer processor, are used for performing a media content generation method comprising:
displaying, in response to a first trigger operation for generating media content, at least two pieces of preview media content on a shooting page according to preset page layout information, wherein content corresponding to the at least two pieces of preview media content is the same;
replacing, in response to detecting that an event of acquiring the media content is satisfied, the preview media content with acquired first media content; and
determining, for the at least two pieces of first media content displayed, second media content in a first style type from the first media content, and displaying the second media content on the shooting page,
wherein content of the at least two pieces of first media content is the same, style types of the second media content corresponding to the at least two pieces of first media content are different, and type information of the style types is related to the preset page layout information.
